(19) United States
(12) Patent Application Publication
(10) Pub. No.: US 2024/0191161 A1
(43) Pub. Date: Jun. 13, 2024

(54) CONTAINER FOR BREWERIES

(71) Applicant: Adrian Michel, Basel (CH)

(72) Inventor: Adrian Michel, Basel (CH)

(21) Appl. No.: 18/555,465

(22) PCT Filed: Apr. 14, 2022
(86) PCT No.: PCT/CH2022/050009

§ 371 Date: Oct. 13, 2023

(30) Foreign Application Priority Data
Apr. 15, 2021 (CH) 00395/21
Nov. 26, 2021 (CH) CH070607/2021

(51) Int. Cl. C12C 7/06; C12C 13/08

(52) U.S. Cl. CPC C12C 7/062; C12C 7/067; C12C 13/08

(57) ABSTRACT

A mixer (I) comprising a mixing container (2) having an internal volume, capable of rotation about a rotation axis (4), the mixer (I) being characterized in that it also comprises at least one ultrasound source (31, 32, 33, 34) capable of exposing at least one portion of said internal volume to ultrasound. The mixer preferably also has a heating system (II) and/or a grid (12) separating a portion of the internal volume of the mixing container (2). The mixer is usable in particular in the brewing of beer.

The present invention relates to a mixer with a rotating mixing container and its use in beer brewing or ice extraction of plants and plant parts such as trichomes.

### STATE OF THE ART

Beer production essentially consists of the following steps: malting (germination of the barley to activate enzymes that hydrolyze starch), kilning (roasting the germinated barley into malt, among other things to form aromatic substances), grinding the malt to a desired grist size, mashing (heating the roasted malt in an aqueous suspension to hydrolyze starch into fermentable sugars, thereby obtaining the wort), lautering (separating the wort from the malt), wort boiling (together with hops to add the bitter substances), knocking (separating of the hops and the proteins from the wort that are precipitated during cooking) and fermentation. Mashing is the step that determines the proportion of fermentable sugar and thus the maximum possible alcohol content of the finished beer. During mashing, it is desirable to mix the malt with the aqueous phase as thoroughly as possible in order to extract as much sugar as possible, but this requires more intensive mixing. On the other hand, it is undesirable for the malt to be ground during mashing because such finely divided abrasion makes lautering more difficult. This requires more gentle mixing.

Depending on the size of the brewery, these work steps are carried out in separate containers (vessels). The largest breweries are designed as four-vessel breweries, with a mash vat, a mash tun, a lauter vat and a wort kettle, which are often arranged one above the other to enable the liquids to be drained from one vessel to the next without a pump. The presence of four separate vessels for each of the four work steps makes this possible to carry out at the same time all four steps on different brewing batches at the same time but requires the greatest amount of space and design effort.

Three-vessel brewing plants are more compact, in which one and the same vessel typically serves as a mash tun and a wort tun and the other two vessels take on the functions of the mash vat and the lauter vat. Two-vessel brewing plants are even more compact, in which one vessel typically serves as a mash tun and a wort tun at the same time and a second vessel typically serves as a mash vat and lauter vat. The most compact design, but typically also with the smallest capacity such as for hobby brewers, is a single-vessel brewing system, in which a single vessel takes on all four functions.

Therefore the brewing capacity tends to increase with the number of vessels operating side by side in different functions at the same time; on the other hand, the space required increases as the number of vessels increases.

Ultrasound has already been used in malting, see U.S. Pat. No. 2,745,789 A. The function of the ultrasound was to accelerate the water absorption of barley and its germination.

DE 101 56829 A1 and CN 201395585Y describe the use of ultrasound in mashing, using conventional fixed mash tuns; CN 201395585Y additionally uses a propeller stirrer mounted in the bottom of the mash tun.

Ultrasound has also been used in wort boiling with hops, see U.S. Pat. No. 2,816,031 A. The use of ultrasound is intended there to enable the colloidal dispersion of the hop resins and thus better extraction of the bitter substances. DE 297 13 506 U1 describes wort boiling or mashing using ultrasonic transducers.

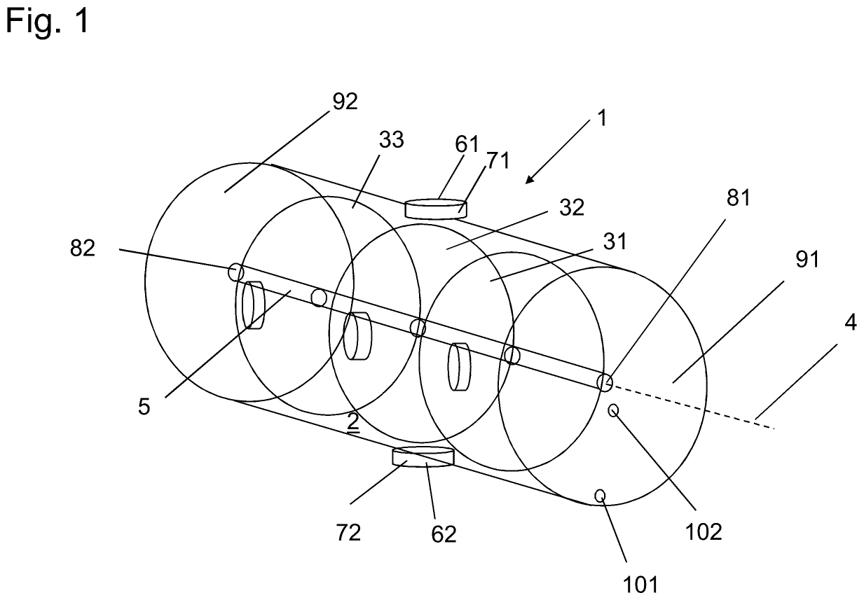

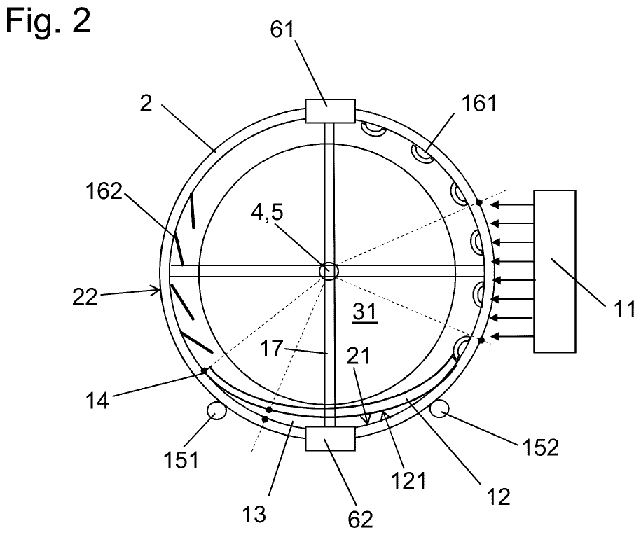

GB 18237 (1913) describes in FIGS. 1 and 2 a lautering process in which the wort is separated from the mash using a perforated rotary drum. DE-PS-826742 also describes a lautering process using a “rotary filter” that separates mash into spent grain and wort.

The use of hydrodynamic cavitation in mashing is also previously known. Journal of Cleaner Production, 142(4), pp. 1457-1470 (2017) e.g. describes the use of a loop reactor, in which there is a Venturi nozzle in the loop, in mashing. The Venturi nozzle creates the hydrodynamic cavitation which is intended to improve the extraction of starch and sugar from the malt. However, it turns out to be difficult to use this process in larger volumes. In addition, the grain is very strongly damaged which causes further disadvantages during lautering.

In many extraction processes and also during mashing the presence of oxygen can be disruptive because it can damage the substances to be extracted or, especially during mashing, the enzymes, flavorings and/or the ascorbic acid which is important for the taste and stability of the beer. When heated, the solubility of the oxygen in the extraction medium drops to around 4-5 ppm at typical mashing temperatures, but the reactivity of this residual oxygen increases with rising temperature. The typically desired residual oxygen concentration during mashing is therefore 0.5 ppm or less. The oxygen is usually removed by degassing the extraction medium and/or by applying a protective gas (nitrogen, carbon dioxide).

The object of the present invention is to provide a mixer that can be used in particular in beer production and takes into account the above-mentioned problems when mixing and enables simpler process control with a high throughput at the same time.

### SUMMARY OF THE INVENTION

According to the invention, the object is achieved by a mixer comprising a mixing container with an internal volume which is capable of rotating about an axis of rotation, the mixer being characterized in that it also comprises at least one ultrasound source which is capable of irradiating at least a portion of this internal volume with ultrasound.

Preferred aspects of the mixer and its application emerge from the dependent claims and the following description.

### DETAILED DESCRIPTION OF THE INVENTION

The mixer according to the invention generates acoustic cavitation using ultrasound. The use of ultrasound itself was previously known in mashing (see above), but to the applicant's knowledge, no successful such processes have been carried out on a large scale to date. With the present invention this becomes possible and the said damage to the grain and the associated problems during lautering are reduced. The mixer according to the invention ensures more uniform sonication with ultrasound than the corresponding previously known mixers.

The mixing container includes an internal volume that holds the material to be mixed. As the “internal volume” of the mixing container is understood the entire volume enclosed by the inner surface of the mixing container, including all internal elements, such as a shaft or axle, any additional mixing tools (see below) and struts (see below).

The mixing container preferably has one or more openings, each of which can be closed in a liquid-tight and/or gas-tight manner by an associated closure. As “liquid-tight” is preferably understood that the opening being closed with its associated closure is waterproof up to the maximum excess pressure compared to the environment that occurs inside the mixing container during its operation and at room temperature (approx. 23° C.). As “gas-tight” is preferably understood that the opening being closed with its associated closure, is airtight up to the maximum excess pressure compared to the environment that occurs inside the mixing container during its operation and at room temperature (approx. 23° C.).

The size and shape of the internal volume are defined by the mixing container when the one or more openings are closed by their closures; however these definitions remain valid and are applicable even if the closures are open or even removed: The volume delimitations that are physically contributed by the closure(s) when closed remain identical as imaginary limitations after the closure(s) has(have) been opened and optionally removed.

The determination of the internal volume of the mixing container can be done for the purposes of the invention, for example, by first closing all the openings of the mixing container except one (“all openings” means all openings that can be closed by means of a closure and the openings of the two bearings); whereby openings that can be closed in a liquid-tight manner by means of a closure are closed with this closure, and openings of the bearings are closed by means of a plug; aligning the mixing container so that the one opening which is not closed faces upwards; completely filling the mixing container via the one open opening with a liquid of known density; closing the one open opening by means of its liquid-tight closure, or, if the one open opening was that of one of the two bearings, with a plug, in such a way that excess liquid is displaced from the opening during closure, whereby a gas-free and completely liquid-filled mixing container is obtained; weighing the gross weight of this liquid-filled sealed mixing container; complete emptying of the liquid from the mixing container; weighing back the tare weight of the empty container and the liquid sealing closures and the two stoppers, and calculate the internal volume as the difference between the gross and tare weights divided by the density of the liquid.

The mixing container's internal volume so determinable depends on the respective area of application of the mixer according to the invention. In a preferred embodiment, particularly if the mixer according to the invention is used in beer brewing, this internal volume so determined is preferably in the range from 1 liter to 30 cubic meters. This internal volume is then more preferably in the range of 1 to 500 liters or in the range of 5 to 20 cubic meters.

As a “mixture” with which the mixer according to the invention is filled can, is understood in the context of the present application a mixture that comprises a portion of liquid or gas and a portion of particulate solid. The liquid or gas can function as an extraction medium for the particulate solid. The suitable liquids that come into consideration are in particular water, aqueous solutions or mixtures of water and a solvent that is miscible with water in any ratio, such as C₁-C₃ alcohols, acetone, oils, tetrahydrofuran or supercritical gases such as supercritical CO₂, supercritical ethane or supercritical propane. Possible gases include subcritical CO₂ or ammonia. The preferred liquid is water. Particulate solids that come into consideration are, in particular, ground, crushed or shredded biomass, in particular cereals, seeds, grains, whole plants, parts of plants such as trichomes, berries, fruits, flowers, or wood chips; wherein the particulate solid may have been subjected to further pretreatments, such as thermal pretreatments for drying and/or roasting, besides said grinding, crushing or crushing. The particle size of the particulate solid is preferably such that it passes through sieve No. 1 and is sieved out by sieve No. 5 when the Pfungstädter Plansifter sieves are used. The weight ratio between liquid and particulate solid in such a mixture is preferably in the range from 10:1 to 1:2.

A preferred example of a mixture with which the mixing container of the mixer according to the invention can be filled comprises barley malt and water and is preferably suitable for mashing in beer breweries.

The filling of the mixing container with the material to be mixed is preferably such that the internal volume of the mixing container is filled to at least 95%, more preferably to at least 99%.

The term “about”, when used together with a numerical value, preferably means in the context of the present application that ±10% deviation from this numerical value is permitted or possible. In particular, “about” preferably means, when used in the context of a lower limit of a range, that this lower range limit can fallen below by up to 10%, and, when used in connection with an upper limit of a range, preferably means that this upper range limit can be exceeded by up to 10%.

The mixing container in the mixer according to the invention is preferably made of a stainless steel approved for food use, for example AISI 316 (material number 1.4404) or AISI 304 or AISI 304 L (material numbers 1.4301, 1.4306 or 1.4307), made of copper, or made of copper-coated steel. If the mixer according to the invention includes a heater (see below), copper or steel coated with copper is preferred in view of optimized heat conduction.

Concerning the mechanical, gentle mixing of malt and liquid, the mixer according to the invention functions largely or even exclusively as a free-fall mixer due to its rotating mixing container. It was surprisingly found that with the mixing ratios of malt to water customary for a mash, i.e. in the range of 1 to 2.5 to 1 to 5 parts by weight, the mechanically gentle mixture according to the principle of the free-fall mixer works satisfactorily in view of maximum sugar extraction with minimal damage on the mixture/grain, and with all grain sizes common for beer production.

Due to the main or exclusive mode of operation as a free-fall mixer, the axis of rotation of the mixing container preferably does not deviate from the horizontal by more than 20°. More preferably, the axis of rotation does not deviate from the horizontal by more than 10°, even more preferably by not more than 5°. The axis of rotation is particularly preferably exactly horizontal.

For example, the mixing container's main axis of inertia with the lowest main moment of inertia is suitable as the axis of rotation for all embodiments of the mixing container capable of rotation.

To enable the rotation of the mixing container the container is rotatably mounted on both sides at the penetration points of the rotation axis through the mixing container or rests on rollers or gears with guide rail.

In a first preferred embodiment for enabling the rotation the mixing container is enabled to rotate via two cylindrical pins attached to the mixing container, the central axes of which lie on the axis of rotation, and which are rotatably mounted on or in bearings arranged outside the mixing container. This embodiment is particularly preferred if the mixing container is to be designed as a pressure container.

In a second preferred embodiment for enabling rotation, the mixing container is enabled to rotate by means of an axis or shaft running along the axis of rotation and which is firmly connected to the mixing container. This firmly connected axle or shaft typically has two extensions similar to the pins mentioned above, which in turn are mounted on two bearings outside the mixing container.

In a third preferred embodiment for enabling rotation, the mixing container is enabled to rotate by means of an in particular rigid axle which is freely rotatable relative to the mixing container and which runs along the axis of rotation of the mixing container. In this case, the mixing container itself has two bearings, by means of which the mixing container can be freely rotated relative to the rigid axle. The axle is then supported outside the mixing container. On the one hand, this axle can run through the entire mixing container. On the other hand, it can be in the form of two, in particular rigid, axle sections which can rotate freely relative to the mixing container and which run along the axis of rotation of the mixing container, but not along the entire length of the mixing container. These axle sections would typically each protrude into one of the two bearings of the mixing container and the mixing container would be rotatably mounted on these two axle sections.

In the case where there is an axle or shaft that is firmly connected to the mixing container and runs through the entire mixing container, struts can radiate from this axis or shaft, which extend to the inner surface of the mixing container and are attached to it, and thus provide for an additional stiffness of the mixing container and an additional mechanical stirring effect.

The mixing container is preferably designed to be rotationally symmetrical about an axis of symmetry when viewed from the outside; more preferably, it has a cylindrical lateral surface and a first and a second end face, which are more preferably also rotationally symmetrical about the same axis of symmetry, more preferably both end faces are flat or have a convex curvature, i.e. they then have the shape of a spherical cap or of a cap cut out of an ellipsoid of revolution. In view of cleaning the mixing container at least one of these two end faces can preferably be removable, for example by being capable to be screwed to the mixing container in a liquid-tight manner and (if the material to be mixed contains a gas) in a gas-tight manner.

In the case of the mixing container which is rotationally symmetrical when viewed from the outside or of the mixing container with a cylindrical lateral surface the axis of symmetry can, in a first preferred symmetry variant, firstly preferably coincide with the axis of rotation because the axis of symmetry is then generally the main axis of inertia with the lowest moment of inertia. The two penetration points of the axis of rotation through the mixing container are then in the center of the end faces, which are also preferably present.

In a second preferred symmetry variant, in the case of the mixing container which is rotationally symmetrical when viewed from the outside or of the mixing container with a cylindrical lateral surface, the axis of symmetry can be inclined relative to the axis of rotation, so that the rotation simultaneously receives a wobble component. In this case, the two penetration points of the axis of rotation are not exactly in the center of the two end faces, which are then also preferably present, but rather somewhat eccentrically therefrom, namely on one end face in one direction offset from their center by a certain distance and on the other end face in the opposite direction from its center, preferably by the same distance. In such a mixer with a wobble component, the intersection point between the axis of symmetry and the axis of rotation is preferably approximately halfway along the axis of symmetry between the two penetration points of the axis of symmetry with the inner surface of the mixing container.

In a third preferred symmetry variant, in the case of the mixing container which is rotationally symmetrical when viewed from the outside or of the mixing container with a cylindrical lateral surface, the axis of rotation can run parallel to the axis of symmetry, but can be offset from it by a certain distance. In this case, the two penetration points of the axis of rotation are again not exactly in the center of the two end faces, which are then also preferably present, but also somewhat eccentric from the center, but on both end faces they are offset in the same direction and preferably by the same distance from the center, in order to ensure the parallelism between symmetry and rotation axes.

In a first embodiment of the drive the mixing container can be put into rotation by a torque acting via its axis of rotation. For this the mixing container has either two pins (according to the above first embodiment for enabling the rotation) or a shaft firmly connected to the mixing container (according to the above second embodiment for enabling the rotation). This form of torque transmission is possible with all mixing containers and is preferred for asymmetrical mixing containers. The transmission of torque by means of the shaft is particularly preferred in the case of a rotationally symmetrical mixer or mixer with a cylindrical lateral surface seen from the outside, if in these the axis of symmetry is inclined relative to the axis of rotation or offset parallel to it (see above).

In a second embodiment of the drive, the mixing container is put into rotation by a torque acting directly on the outer surface of the mixing container. This second embodiment is preferred for mixing containers that are rotationally symmetrical when viewed from the outside or that have a cylindrical lateral surface. In this embodiment, the torque can be transmitted from a drive motor from the outside by means of rollers to the outer surface in a first variant of torque transmission of the mixing container. For this purpose, the rolling surfaces of these rollers or platens can preferably be coated with a material that has a high static coefficient of friction with the outer surface of the mixing container, such as a rubber layer. If the mixing container is heatable (see below) this rubber layer is then preferably made of a heat-resistant silicone rubber. Also preferably, in this first variant of torque transmission from the outside, these rollers or platens run on the underside of the mixing container and along the entire length of the mixing container; in this case the mixing container has a cylindrical outer shape. If the rollers or platens run on the underside and along the entire length of the cylindrical mixing container not only a torque transmission but also an additional support of the mixing container is achieved. In a second variant of torque transmission from the outside, a transmission belt is provided which acts on the outer surface of the mixing container. In a third variant of torque transmission from the outside, the outer surface of the mixing container can have an annular gear ring which engages in a gear attached to the drive motor and thus ensures the transmission of the torque from the drive motor to the mixing container. In this third torque transmission variant, the outer surface of the mixing container is rotationally symmetrical at least at the point where the ring gear is attached.

In all embodiments of the mixer according to the invention, which has a cylindrical lateral surface, rollers can be provided along the entire length of the lateral surface and on its underside, as described above in the first variant of torque transmission from the outside, these rollers not effecting torque transmission but only resting on the outer surface of the mixing container and rotating passively while supporting the mixing container from below.

In all embodiments of the drive and all variants of torque transmission, a gear can be interposed that reduces the initial (usually probably too high) speed of the drive motor.

The drive motor and torque transmission to the mixing container are preferably designed in such a way that the mixing container is capable of rotating in the range of 1 to 15 rpm when filled with mixture.

In a first preferred embodiment of the mixing, the mechanical mixing is effected by picking up the material to be mixed exclusively by friction on the inner wall of the mixing container and then dropping it freely through the mixer space due to its own gravity. In this first preferred embodiment, no additional mixing tools such as blades, knobs or waves are attached to the inner surface of the mixing container; the inner surface of the mixing container is therefore smooth.

In a second preferred embodiment of the mixing, the inner surface of the mixing container has unevennesses which support the lifting of the mixed material contained therein. These unevennesses can be in the form of a profiling of the inner surface, for example in the form of knobs or thresholds. If they are thresholds, they can either run approximately parallel to the direction of rotation of the mixing container, or they can run in a clockwise or counterclockwise spiral along the inner surface of the mixing container. In the latter case, clockwise and counterclockwise thresholds can be combined in equal proportions and in an otherwise identical design. These thresholds can run along the entire inner surface of the mixing container or they can be designed as segments, each of which only extends along part of the inner surface. The unevennesses can also be designed as actual mixing tools, for example in the form of blades, baffles or stirring rods.

The mixer according to the invention has at least one ultrasound source which is capable of irradiating at least part of the internal volume of the mixing container, preferably for irradiating its entire internal volume. If the mix comprises a liquid, this sonicated part of the internal volume is preferably the part that is filled with mix and/or comes into contact with mix. Such ultrasonic sources can on the one hand, be attached to the outside of the rotating mixing container. On the other hand, and preferred according to the invention, the at least one ultrasound source is arranged inside the mixing container. More preferably, the one or more ultrasonic sources are one or more ultrasonic vibrating plates that are mounted inside the mixing container. Such submersible oscillators in the form of oscillating plates are already known. These are plates made of a material that conducts ultrasound well, in particular metal, preferably a stainless steel approved for food use, as exemplified above, on which electromechanical or piezoelectric converters are attached in a two-dimensional grid, preferably a square grid, which generate the ultrasound in phase and transfer it to the vibration plate. The ultrasonic vibrating plate acts as an ultrasonic resonator and therefore has a resonance frequency that corresponds to the frequency of the ultrasound generated by the converters, and preferably has a thickness that corresponds to half the wavelength of the ultrasound to be generated. These ultrasonic vibrating plates mounted inside can preferably, on the one hand, be perpendicular to the axis of rotation of the mixing container, so that their surface normal runs parallel to the axis of rotation of the mixing container. In this case, they are round (particularly circular) or angular (particularly square). In this case, they are either attached to the inside of the mixing container or to a shaft, whereby they can rotate with the mixing container, or they are attached to a shaft running inside the mixing container and firmly connected to the mixing container (according to the above second embodiment to enable the rotation), or they are attached to an in particular rigid axis running inside the mixing container and freely rotatable relative to the mixing container (according to the third embodiment above to enable rotation). Such ultrasonic oscillating plates irradiate the interior of the mixing container (or the part thereof) in such a way that the oscillation plane of the ultrasound runs in the direction of the axis of rotation.

On the other hand, or in addition to those described above perpendicular standing ultrasonic oscillating plates, one (preferably exactly one) ultrasonic oscillating plate mounted inside can be present in such a way that the axis of rotation of the mixing container lies within this oscillating plate and the surface normal of this ultrasonic oscillating plate is perpendicular to the axis of rotation. This one oscillating plate with surface normal perpendicular to the axis of rotation is preferably arranged so that its surface normal is inclined relative to the vertical, approximately at an angle of 20° to 40°. For the use of such an ultrasonic oscillating plate it is preferred if the mixing container has a cylindrical interior and this ultrasonic oscillating plate has a rectangular shape, such that the longer side runs in the direction of the axis of rotation and the shorter side is perpendicular to the axis of rotation. Such an ultrasonic oscillating plate irradiates the interior of the mixing container (or the part thereof) in such a way that the oscillation plane of the ultrasound runs perpendicular to the axis of rotation.

If this oscillating plate with surface normal perpendicular to the axis of rotation is present, whether alone or in combination with the above-discussed oscillating plates with surface normal parallel to the axis of rotation, it is preferably mounted on an in particular rigid axis running inside the mixing container and being freely rotatable relative to the mixing container (according to the above third embodiment to enable rotation).

On the other hand, the ultrasound source can more preferably have the shape of a box profile or a square tube which runs in particular in the interior of the mixing container in its longitudinal direction and which has one or more ultrasound generators in the interior of the box profile or square tube, which serve to irradiate the surroundings of the box profile or square tube; i.e. the direction of sound propagation of each ultrasonic generator contained therein is from the inside of the box profile or square tube to the outside. Before installation in a device according to the invention such an ultrasound source is open on both end faces of the box profile or square tube; after installation in the device according to the invention the box profile or square tube is sealed at least liquid-tight on both end faces, since the ultrasonic generators should not be directly exposed to the mix which usually contains a liquid. Such a sealing can be achieved upon installation in the mixing container through the end faces of the mixing container and/or through axle sections of the mixing container and/or through profile end plates which close the two end faces of the box profile or square tube. However, the at least liquid-tight sealing is such that the power supply to the ultrasonic generators present inside the box profile or square tube is guaranteed via suitable cables or lines. Such an ultrasound source in the form of a box profile or square tube, which is either open on both end faces or at least liquid-tightly sealed on both end faces, is new to the inventor's knowledge and could also be an object of the invention. The closest known ultrasonic sources of similar design are already known in the field of ultrasonic baths for cleaning, but there the ultrasonic sources are attached to the outside of the box profile or square tube and are used to provide sound to its interior, i.e. the direction of sound propagation of each ultrasonic generator attached to it is from the outside to the inside.

An ultrasonic vibration plate designed, oriented and fastened in this way with surface normal perpendicular to the axis of rotation, or an ultrasound source in the form of a box profile or a square tube which runs in the longitudinal direction inside the mixing container, brings about upon rotating operation of the mixing container that the mix is simultaneously mixed evenly and exposed to the acoustic cavitation in the interior, because the particulate solid of the mix falls or floats on the ultrasound source(s). In addition, the mix picked up through the inner wall of the mixing container can fall onto this ultrasonic vibrating plate and run or trickle down it and at the same time is exposed to ultrasound through it. This significantly increases the extraction effect of the liquid or gas in the mix on the particulate solids of the mix.

The frequency of the ultrasound that the ultrasound source(s) generate is preferably in the range of 20 to 100 kHz, more preferably 25 to 80 kHz. In a more preferred embodiment, the frequency of the ultrasound wobbles, i.e. it varies over time, in particular periodically, between a minimum and a maximum frequency. From the previously known methods with hydrodynamic cavitation it is known that a high density of cavitation bubbles with little strength, i.e. that are generated with high frequency, has the best effect. According to the invention, this can be used and effected analogously to acoustic cavitation.

For the combination of ultrasound sources arranged within the mixing container, in particular vibrating plates, their power supply and the torque transmission required to rotate the mixing container there are four preferred embodiments.

The first preferred combined embodiment includes the above first preferred symmetry variant, the above third preferred embodiment to enable the rotation of the mixing container, the transmission of the torque to the mixing container takes place according to one of the three variants of torque transmission from the outside exemplified above, and the ultrasound source(s) is(are) attached to the rigid axle and is(are) therefore also rigid. The ultrasound sources are powered here via the rigid axle which heretofore has suitable electrical lines. If desired, this axle can also be hollow on the inside and have perforations to enable pressure equalization and/or the supply or discharge of liquid (see below).

The second preferred combined embodiment includes the above first preferred symmetry variant, the above second preferred embodiment for enabling the rotation of the mixing container with a firmly connected axis, the torque is transmitted from the outside according to one of the three variants of torque transmission exemplified above, and the ultrasound source(s) is(are) attached to the axle and therefore rotate(s) with the axle and the mixing container. In order to ensure the power supply to the ultrasonic sources, two slip rings, which are common in technology, can be attached to the outside of the mixing container, which interact with stationary brushes, in particular carbon brushes, which brush over the slip rings and thus enable the transfer of electrical current from a static voltage source to the rotating mixing container. An insulated electrical conductor leads from each of the two slip rings via a passage in the jacket of the mixing container into its interior volume and to the ultrasonic sources, in particular ultrasonic vibration plates, attached to the axle. Alternatively, only one slip ring/brush pair can be attached to the outside of the mixing container, with an insulated cable leading into the interior of the mixing container as described above; a second slip ring is mounted on the axle and interacts with a second brush. The current transmitted to the axle or shaft can be conducted to the ultrasound sources by means of an insulated electrical conductor. Alternatively, two mutually insulated slip rings can be mounted on the axle, each interacting with an associated brush. Here the axle provides the complete power supply to the ultrasound sources via two insulated electrical conductors. If desired, this axle can also be hollow on the inside and have perforations to enable pressure equalization and/or supply or drainage of liquid (see below).

The third preferred combined embodiment includes the above first preferred symmetry variant, the above second preferred embodiment for enabling the rotation of the mixing container with a firmly connected shaft, the transmission of the torque takes place according to the above first embodiment via the axis of rotation, and the ultrasound source(s) is(are) attached to the shaft and therefore rotate(s) with the shaft and the mixing container. The power supply to the ultrasound source(s) is the same as in the second preferred combined embodiment above, with the proviso that all references to the “axle” are replaced by references to the “shaft”.

The fourth preferred combined embodiment includes the above first preferred symmetry variant; the above third preferred embodiment for enabling the rotation of the mixing container with two in particular rigid axle sections which are freely rotatable relative to the mixing container and which protrude into the two bearings of the mixing container; the torque is transmitted according to the above second embodiment from the outside to the outer surface of the mixing container; and the ultrasound source(s) is(are) connected to the two rigid axle sections. The power supply to the ultrasound source(s) is the same as in the above second preferred combined embodiment, with the proviso that all references to the “axle” are replaced by references to one of the two “axle sections”.

Most preferred are the first and fourth of the above four preferred combined embodiments.

In a first embodiment of temperature control, the mixer according to the invention does not include a heater. If it is used in the form in the beer brewery, it would be suitable for mashing using infusion or decoction processes. The heat required for these processes could still be supplied to the mash using separately heated water or a separated, separately heated partial volume of the mash. This first embodiment is also suitable for extraction processes with cooling, in which the mixture is either cooled internally with the additional addition of ice (see below) or cooled externally using cooling units and external cooling coils.

In a second embodiment of the temperature control, the mixer according to the invention comprises a heater arranged outside the mixing container. This external heater can be an induction, gas or steam heater, particularly if the mixing container is made of metal as exemplified above. In the case of induction heating, the mixing container could typically be wrapped with a coil which provides the alternating magnetic field energy required for the induction heating of the (then necessarily electrically conductive) mixing container. Also in the case of induction heating, the mixing container (which can then be electrically conductive or electrically insulating) could preferably be additionally filled with susceptors in the form of electrically conductive, in particular metallic, shaped bodies, in particular in the form of spheres, during operation. These would also be heated inductively and would ensure a more even heating of the mix. These susceptors could advantageously also be designed to be hollow in order to have a density such that they float as much as possible in the mix by means of buoyancy and thus avoid as much as possible a grinding effect on the mix and the particulate solid contained therein.

With a heating system arranged outside the mixing container, it is possible, but not necessary, for the entire mixing container to be heated. A permanently installed external heater, which heats only part of the mixing container (i.e. in particular only part of the outer surface of the mixing container), is sufficient. Once the mixing container has been selected and given and the geometry of the heating, the number of heating elements, the thermal performance of the heating and the distance between the heating and the outer surface of the mixing container have been selected and given, this “heated” part is limited and defined by a closed curve on the outer surface of the mixing container, as follows: Two points of this closed curve, which simultaneously lie on a cross section through the mixing container that is perpendicular to the axis of rotation, are defined by that they are the two points at which the temperature measured on the outer surface of the mixing container during heating is no more than 5° Celsius above the constant or constant ambient temperature (i.e. room temperature, approx. 23° C.), whereby the measurements are carried out with the mixing container at a standstill, in empty state and in thermal equilibrium of the mixing container. To determine this “heated” part of the outer surface, all cross sections through the mixing container in which the two points are separated by a maximum of 5° temperature difference are taken into account. Cross sections in which only one such point is visible (the two points thus coincide) are considered the boundary of this “heated” part of the outer surface in the direction of the axis of rotation.

Preferably, for a given mixing container, the outer heater, the geometry of the heater, the heating power and the distance between the heater and the outer surface of the mixing container are selected so that the “heated” part of the outer surface as defined and determined above is such that at every possible cross section through the mixing container as defined above, the said two points with a maximum of 5° temperature difference, if each of them is connected to the rotation axis by an imaginary line that runs perpendicular and radial to the axis of rotation, include together with and between these imaginary lines an angle of at the most 30°, this being regardless of the rotational position of the mixing container with respect to the heating.

In a third embodiment of the temperature control, the mixing container includes a heater arranged inside. Typically, it is an electrical heating in the form of one or more ohmic heating elements, such as rods. These ohmic heating elements are made of a material that is electrically conductive but has a sufficiently large ohmic resistance to heat up when current passes through it. The preferred material for these ohmic heating elements is graphite. The heating elements can comprise an electrically insulating, heat-resistant covering, for example made of a ceramic material.

On the one hand, these internal heating elements can be rigid, i.e. they cannot rotate with the mixing container. For this purpose, they are typically attached to a rigid axle running inside the mixing container or to the two rigid axle sections, which can be freely rotated relative to the mixing container and protrude into bearings in the mixing container. They can also be attached to an equally rigid ultrasound source, which in turn is attached to a rigid axis or to rigid axis sections running inside the mixing container, which is (are) freely rotatable relative to the mixing container. In this first case of rigid internal heating elements the above third preferred embodiment for enabling rotation with only two axle sections that protrude into the two bearings of the mixing container is particularly preferred. The mixing container is then preferably set in rotation by means of the above second embodiment of torque transmission from the outside and the mixing container then preferably has a cylindrical lateral surface. The ultrasound sources here are preferably in the form of also rigid box profiles or square tubes that contain ultrasound generators inside. The provision of current of these rigid heating elements is preferably via lines or cables that pass through the axle sections and into the heating elements.

On the other hand, the heating elements arranged inside the mixing container can be fastened to the mixing container and rotate with it. In this second case of heating elements rotating with the mixing container, any of the above preferred embodiments for enabling rotation and any of the above embodiments for applying torque are possible. The ultrasonic sources here are preferably in the form of ultrasonic oscillating plates with surface normals parallel to the axis of rotation, which can be provided with suitable openings through which these axial heating elements pass without touching the ultrasonic oscillating plates and thus avoiding their damping. In the case of angular such ultrasonic oscillating plates, these heating elements would typically run in the recesses that exist between the inner wall of the mixing container and the edges of the angular ultrasonic oscillating plates. The power supply to these heating elements connected to the end faces or the inner surface of the mixing container is preferably via slip rings that are attached to the outside of the mixing container and interact with stationary brushes (see above).

In a fourth embodiment of the temperature control, the mixing container can include a cooling arranged in its interior. This can be a cooling element similar to a cooling coil in a cooling slim or a heat exchanger. In both cases, the supply and removal of the coolant can be done with cooling lines that enter the mixing container through two rigid axle sections that are freely rotatable with respect to the mixing container and which protrude into the two bearings of the mixing container. This cooling is then typically firmly connected to the two rigid axle sections. The torque is transmitted according to the above second embodiment from the outside to the outer surface of the mixing container; and the ultrasound source(s) is(are) also connected to the two rigid axle sections. The power supply to the ultrasound source(s) is the same as in the above second preferred combined embodiment, with the proviso that all references to the “axle” are replaced by references to one of the two “axle sections”.

In the case of a mixing container with a cylindrical lateral surface and two end faces, these internal heating elements, in particular in the form of rods, would typically be axially positioned over at least part of the length of the mixing container (e.g. over 70-95% of this length), or over the entire length of the mixing container from one end face of the mixing container to the other.

Also preferably for a given mixing container, the outer heater or the inner heating elements, the geometry of the heater or of the heating elements, the heating power and the distance between the outer heater and the outer surface of the mixing container are selected such that the internal volume of the mixing container, in rotating state and filled with mix, can be heated up to an internal temperature of about 90° Celsius, or up to 80° Celsius.

In the preferred heatable form an excess pressure can arise inside the mixing container of the mixer according to the invention during heating.

In a first, simplest variant, the mixing container, including its openings, closures and bearings, is designed to be sufficiently pressure-resistant to withstand this excess pressure without pressure equalization and without liquid or gas escaping. This excess pressure (relative to the environment) normally moves, especially if the maximum heating temperatures specified above are maintained and the mix is a liquid or a subcritical gas, typically in the range of 0 to 0.7 bar; if the mixture comprises a supercritical gas, they are typically in the range of 50 to 200 bar. Such excess pressures can be easily withstood by pressure containers and closures that are technically possible. Preferably, the above-mentioned second preferred combined embodiment is used here for the combination of ultrasound sources arranged within the mixing container, their power supply and transmission of the torque transmission required for rotation of the mixing container, because no pressure-resistant bearings integrated in the mixing container are required here.

In a second variant, to compensate for excess pressure, the mixing container has an in particular rigid axle which is freely rotatable relative to the mixing container according to the above third preferred embodiment to enable rotation, the axle carrying the ultrasonic sources, in particular ultrasonic vibrating plates. For this second variant of pressure equalization, the above first combined embodiment of ultrasound sources arranged within the mixing container, in particular vibrating plates, their power supply and the torque transmission required for rotation of the mixing container is preferred. Here, however, this axle is also hollow on the inside, whereby its inner cavity being in liquid and/or gas-conducting contact with the interior volume of the mixing container by means of perforations. These perforations are preferably circular and with a diameter that is sufficiently small not to allow any particles of the particulate solid to pass through. This internally hollow axle typically begins to fill with liquid from the mix as soon as such mix is filled into the mixing container up to a filling level that is at least partially above the axle. The internally hollow axle leads out of the mixing container and is connected to a riser pipe that is also hollow and open at the top. This riser pipe can be designed as a rigid pipe pointing upwards or as a hose pointing upwards. This riser pipe leads up to a height such that a column of liquid can stand in it that is so high that its hydrostatic pressure is the same as a maximum permissible pressure inside the mixing container and may also show the filling level of the container in a sight glass. With this variant, pressure equalization between the mixing container and the environment is possible via the internally hollow axle and the riser pipe by means of fluid displacements. When the pressure in the mixing container increases, an additional portion of the liquid contained therein is pressed through the perforations of the axle into the hollow axle and into the riser pipe, whereupon the liquid level in the riser pipe rises. This causes the hydrostatic pressure in the riser pipe to increase slightly and, on the other hand, to compensate for the increasing internal pressure in the mixing container. If the internal pressure in the mixing container drops, liquid flows from the riser pipe back into the internally hollow axle and through its perforations into the interior of the mixing container, whereupon the liquid level in the riser pipe drops. This reduces the hydrostatic pressure in the riser pipe and compensates for the falling internal pressure in the mixing container. Since the pressure fluctuations in the mixing tank are slow and the fluid exchange between mixing tanks is rapid, the system is always almost in equilibrium, in which the said hydrostatic pressure in the riser is always equal to the pressure in the mixing tank. For this second variant, the above-mentioned first preferred embodiment is preferably used for the combination of ultrasound sources arranged within the mixing container, their power supply and transmission of the torque transmission required for the rotation of the mixing container, because here no rotatable bearing between the axle and the riser pipe is required.

In a third variant, to compensate for excess pressure, the mixing container also has an in particular rigid axle freely rotatable relative to the mixing container according to the above third preferred embodiment to enable rotation, the axle carrying the ultrasonic sources, in particular ultrasonic vibrating plates. For this third variant of pressure equalization, the above first combined embodiment of ultrasound sources arranged within the mixing container, in particular vibrating plates, their power supply and of the required torque transmission for rotating the mixing container is therefore also preferred. However, the axle is not continuous here, but interrupted at one point. One or more of the ultrasonic sources, in particular ultrasonic vibrating plates, can be attached to each of the two sections of the interrupted axle. For additional fixation of these sections of the axle, struts can be provided as described above, but here they rotatably surround the section of the axle by means of an external bearing and thus at the same time enable this section to be supported on the inner wall of the mixing container and its free rotation relative to this section. This additional support is particularly advantageous if the said interruption of the axle is close to one of the two penetration points of the rotation axle through the mixing container and when there is a very short section of the axle (presumably without ultrasonic sources, in particular ultrasonic vibrating plates) and a long section of the axle (probably with all ultrasonic sources, especially ultrasonic vibrating plates), and this long section should be additionally supported. One of the two sections of the axle is hollow on the inside and open at its end facing into the mixing container, so that this section is in liquid and/or gas-conducting contact with the interior volume of the mixing container. This opening in the mixing container is preferably circular and has a diameter that is sufficiently small so that no particles of the particulate solid can pass through. This internally hollow section of the axle typically begins to fill with liquid or gas from the mixed material as soon as such mixed material is filled into the mixing container up to a filling level that is at least partially above the axle. The shorter section of the axle, which is hollow on the inside, leads out of the mixing container and is connected to a riser pipe that is also hollow and open at the top. The mode of operation of the pressure equalization with this riser pipe which is open at the top is the same as in the second variant described above.

In a fourth variant, the mixing container can have a diaphragm with a gas-permeable but liquid-tight membrane clamped therein at least at one point (for example at one of the closures). This diaphragm enables gradual pressure equalization through the escape of gas, in particular oxygen, carbon dioxide, nitrogen and/or argon, but not the escape of liquid. The diaphragm functions during the rotation of the mixing container due to the alternating immersion into the liquid level (membrane tight) and when emerging from the liquid level (membrane allows pressure equalization through gas passage). During subsequent cooling, the diaphragm compensates for any negative pressure that may develop by allowing gas to flow back through it. Such gas-permeable but liquid-tight membranes are known. These are in particular membranes made from perfluorinated polymers, such as polytetrafluoroethylene. Due to the perfluorinated and therefore chemically inert state, such membranes are also approved for food applications.

Due to the rotation of the mixing container, local overheating of the mixing container and/or the associated deterioration, inactivation or denaturation of components present in the mix and/or a boiling delay are practically impossible. In this embodiment with heating, the mixer according to the invention is suitable for the kettle mashing process in addition to the two mashing processes mentioned above.

To ensure a desired temperature program during heating, the mixing container of this preferred embodiment preferably also has one or more temperature sensors, of which typically at least one is arranged near the inner surface of the mixing container, or directly on its inner surface, and at least one near the axis of rotation is arranged directly on the axis of rotation (i.e. directly on an axle or shaft running along the axis of rotation). The measurement signals can be carried out via cables, similar to those exemplified above for the power supply of the ultrasound sources, or via radio. The sensors can be powered by a battery or accumulator or also via cables as exemplified above for the power supply of the ultrasound sources.

In a preferred embodiment of the mixer according to the invention a part of its internal volume is separated from the rest of its internal volume by means of a grid running close to the internal surface of the mixing container; in such a way that the transfer of liquid from the rest of the internal volume into the separated part of the internal volume is possible, but not the transfer of particulate solid. The grid performs the function of a sieve during a step of filtering particulate solid from liquid.

If the mixer according to the invention is to be used in beer production, the grid is the sieve for the malt, particularly during a lautering step, and is therefore preferably sufficiently fine-meshed to prevent the passage of malt particles even in the finest possible grinding usual for beer production. The mesh size of the grid is preferably in the range from 1.3 to 0.1 mm, which is the usual range for retaining husks or malt semolina in the usual shot sizes for beer production. The grid then preferably has one of the following mesh sizes:

| | |
|---|---|
| mesh size | solid preferably filtrable from malt grinding |

| | | |
|---|---|---|
| 1.25 | mm | husks |
| 1 | mm | coarse semolina |
| 0.5 | mm | fine semolina 1 |
| 0.25 | mm | fine semolina 2 |

The sieve particularly preferably has a mesh size in the range from 0.1 to 0.25 mm in order to be able to filter out all of the malt solids mentioned above at the same time.

The grid is preferably designed in the form of a perforated grid and preferably also consists of a metal as exemplified above for the mixing container. The above references to “mesh sizes” are to be understood in this case as references to “hole diameters” of preferably approximately circular holes in the perforated grid.

The grid preferably separates only a small part of the internal volume from the rest of the internal volume of the mixing container, more preferably 5-15% of this internal volume. This separated part of the interior volume is defined on the one hand by the geometric outer surface of the grid and on the other hand by the area of the inner surface of the mixing container adjacent to the separated part of the interior volume, and is closed by the connecting seam from the edge of the grid to the inner surface of the mixing container.

In order to delimit a part of the interior volume as defined above from the rest of the interior volume, said geometric outer surface of the sieve is preferably curved in such a way that on every imaginary line that points perpendicularly and radially outwards from the axis of rotation of the mixing container, there is a first distance between the axis of rotation and the point of intersection of this line with the geometric outer surface of the grid which is at the most 10% smaller than a second distance between the axis of rotation and the point of intersection of this line with the inner surface of the mixing container, whereby the percentage difference between the first and second distance is largest for such imaginary lines from the axis of rotation that point to a center or centerline of the sieve; is smaller for imaginary lines pointing from the axis of rotation to a point other than the center or the centerline of the grid, and approaches zero or becomes zero for such imaginary lines pointing from the axis of rotation to said connecting seam. More preferably, this percentage difference falls monotonically from those imaginary lines that point to the center or center line of the grid to those imaginary lines that point to the connecting seam. In a particularly preferred embodiment, if the mixing container has a cylindrical interior volume that is defined by an inner surface with a first radius of curvature, the grid has the shape of a cylinder segment, the geometric outer surface of which has a second radius of curvature that is larger than the first radius of curvature, in particular, the second radius of curvature being 1 to 10% larger than the first radius of curvature.

The grid can be firmly welded or glued to the inner surface of the mixing container so that the said connecting seam is a weld seam or an adhesive joint. Alternatively, especially if the mixing container has a cylindrical interior volume and the grid has the shape of a cylindrical segment, the grid can be interchangeably clamped in suitable holders which are attached to the inner surface.

For the purpose of filtering by means of the grid, the mixing container in this case has at least one closable opening, which lies in the separated part of its internal volume from the environment, which can be closed in a liquid and/or gas-tight manner by means of a closure, and which is used to drain away liquid from the separated part of the internal volume. On the other hand, the mixing container in this case also has at least one opening which leads from the environment into the rest of the internal volume, which can be closed in a liquid and/or gas-tight manner by means of a closure, and which is used to fill the mix into this remainder of the internal volume and/or or is capable of diverting mix from this remainder of the internal volume.

The invention is described below with reference to exemplary embodiments illustrated in the drawings. There shows:

FIG. 1 a transparent perspective view of the mixing container of a mixer according to the invention;

FIG. 2 a sectional view of the mixing container of the mixer according to the invention of FIG. 1; the cutting plane being perpendicular to its axis of rotation;

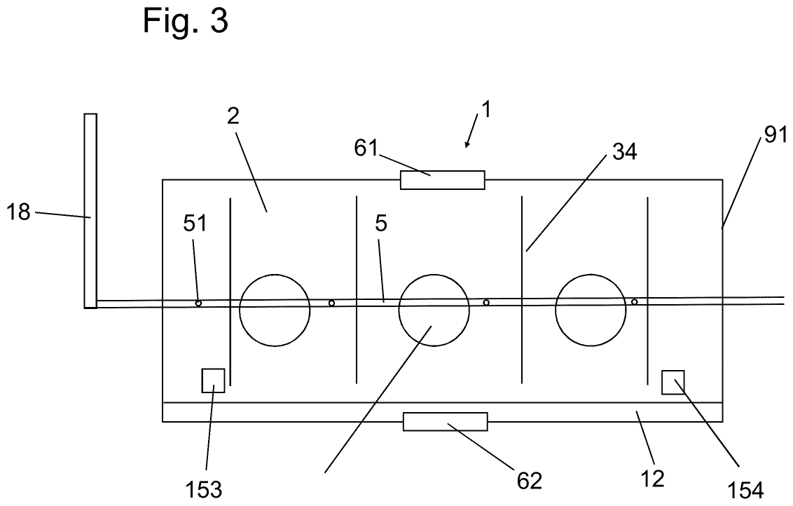

FIG. 3 a transparent, schematic side view of the mixing container of a mixer according to the invention;

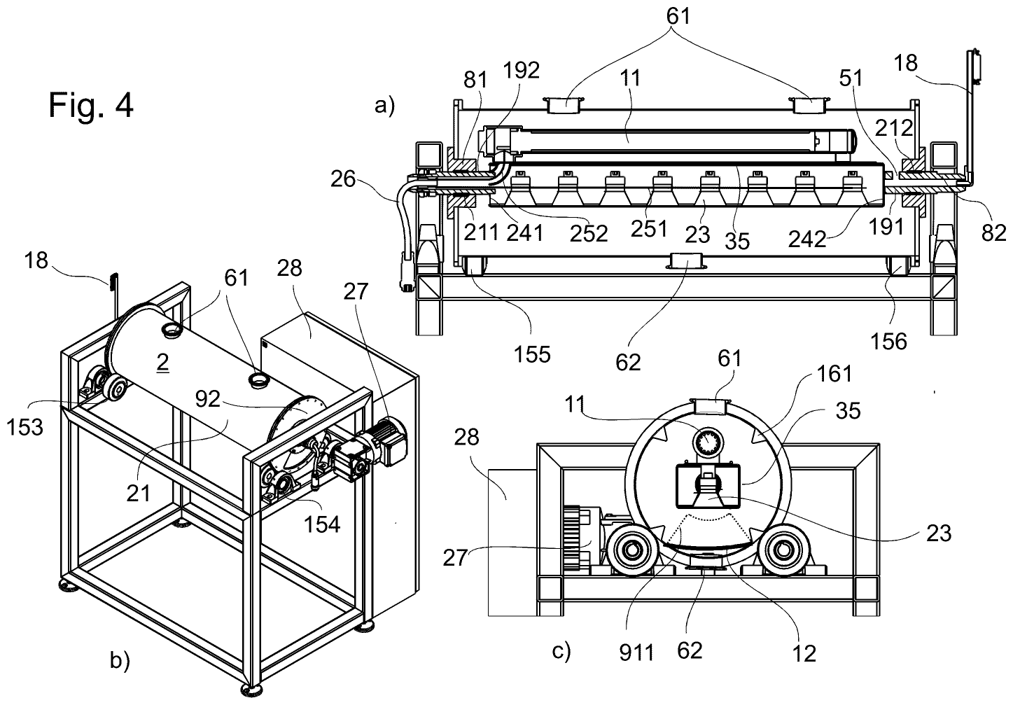

FIG. 4 various views of an embodiment of a mixer of the invention with a mixing container which has an ultrasound source in the form of a box section or square tube;

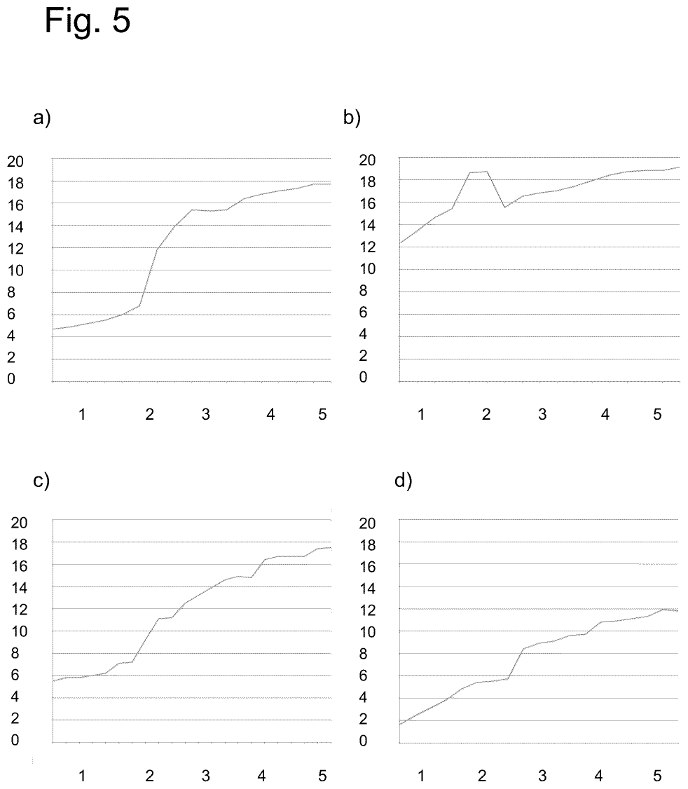

FIG. 5 the results of four mashing tests under different conditions in which a mixer according to the invention with a design according to FIG. 4 was used.

FIGS. 1 and 2 illustrate a preferred embodiment of the mixer 1 according to the invention with a rotationally symmetrical mixing container 2, in particular a mixing container 2 with a cylindrical outer surface 22. The mixing container 2 has an internal volume of approximately 15 m³. FIG. 1 shows a transparent representation of its mixing container 2. This mixing container 2 has a cylindrical outer shape and an axle 5 running along its axis of rotation 4. In this embodiment, the axle 5 is freely rotatable relative to the mixing container and does not rotate with the mixing container 2, it is therefore rigid. The axle 5 runs through two bearings 81,82 each of which is mounted in one of the two end faces 91,92 of the cylindrical mixing container 2. In this embodiment, at least one of the two end faces 91,92 is removable in order to simplify cleaning of the interior volume of the mixing container 2.

The mixing container 2 includes four ultrasonic vibrating plates 31, 32, 33, 34 arranged in its interior, which are only attached to the non-rotating axle 5. Three of these are ultrasonic vibration plates 31, 32, 33 of the type described above, in which the surface normal runs parallel to the axis of rotation. The fourth ultrasonic vibrating plate 34 is of the rectangular type described above, in which the surface normal is inclined to the vertical by a certain angle of approximately 20° (indicated by dashed lines in the figure). In this embodiment, the ultrasound generators (not shown) on the vibration plates 31, 32, 33, 34 are powered via the non-rotating axle 5. The total ultrasonic power of the three ultrasonic plates is about 29 kW; the direction of propagation of the ultrasound is approximately along the axis of rotation 4.

The mixing container 2 also includes five openings, each of which can be closed in a liquid-tight and/or gas-tight manner by means of a closure (two of the openings are provided with reference numbers 61,62 and the associated closures with reference numbers 71,72).

In this embodiment, the mixer according to the invention can be heated. This heater is indicated in FIG. 2 with the reference number 11; FIG. 1 shows two associated temperature sensors 101,102, which are arranged on the first end face 91 of the mixing container 2, of which the first, 101, is arranged near the inner surface 21 of the mixing container 2 and the second, 102, near the axis of rotation 4. FIG. 2 is a sectional view through the mixing container 2, with the section plane parallel to and close to the vibrating plate 31, as shown in FIG. 1. The mixing container 2 can be heated by means of a heating 11. The “heated” part of the outer surface, as defined in the general part of the description, is visible here only as its two points (black dots), which lie simultaneously on the cross section through the mixing container shown in FIG. 2. Two dashed lines run perpendicularly and radially from these two points to the axis of rotation 4, which connect the two points with this axis of rotation in such a way that the two points together with the two lines and between these lines form an angle of just about 30°. These two points represent two points on the boundary line of the “heated” part of the outer surface of the mixing container, these two points lying on the cross section through the mixing container shown here. For every other cross section that is offset from the cross section shown here in the direction of the axis of rotation 4, two new points of this boundary line would result.

The embodiment shown in FIGS. 1 and 2 is also equipped with a grid 12, which, if used in a beer brewery, would serve, among other things, to lauter the mash. This grid 12 separates a part 13 of the interior volume of the mixing container 2 running close to the inner surface 21 of the mixing container 2 from the rest of its interior volume. An opening 62 that can be closed in a liquid and/or gas-tight manner (it would be the same opening 62 as in FIG. 1) enters from the environment into this separated part 13 of the internal volume. The separated part 13 of the interior volume shown here corresponds to a preferred embodiment from the general part of the description: The said geometric outer surface 121 of the grid 12 is curved in such a way that the distance that is measured between this outer surface 121 and the inner surface 21 of the mixing container 2 along each imaginary line pointing perpendicularly and radially outwards from the axis of rotation 4 of the mixing container 2 decreases monotonically from the center line of the grid (this would be at the location of the opening 62 and would be perpendicular to the plane of the sheet) to the connecting seam 14 between the grid 12 and the inner surface 21 of the mixing container 2. Two exemplary dashed lines are shown. In the first, which is closer to the opening 62, such a distance is indicated by two black dots; it is approximately 10%-20% of the distance measured on this line between the axis of rotation 4 and the point of intersection of this line with the outer surface 21 of the mixing container (the lower of the two black points). In the second one, which runs towards the connecting seam 14, this distance is just zero, which is shown as just one black dot.

In the embodiment of FIGS. 1 and 2 the torque is transmitted to the outer surface 22 of the mixing container 2 by means of rollers 151, 152 and 153, 154. The rollers preferably run on the underside and along the entire length of the cylindrical mixing container 2.

The mixer according to the invention of this embodiment can also include mixing tools in the form of thresholds 161 or blades 162 arranged on the inner surface 21 of the mixing container 2. In this embodiment, it can also comprise struts inside the mixing container 2 (one of four is provided with reference number 17) which on the one hand are firmly connected to the inner surface 21 of the mixing container 2 and on the other hand are rotatably mounted on the non-rotating axle 5. For this purpose, these struts can optionally also pass through the grid 12 at a passage point, as shown in FIG. 2. These struts 17 bring about an internal static stiffening of the mixing container 2 and can at the same time take on the function of additional mixing tools.

FIG. 3 shows a further embodiment of the mixer according to the invention. Here it comprises a rigid axle 5, which is hollow on the inside and has a plurality of perforations (one is provided with reference number 51). The perforations establish a connection between the internal volume of the mixing container 2 and the cavity in the axle 5. The axle 5 leads to an upward-pointing riser pipe 18. The axle 5 and the riser pipe 18 typically fill with liquid up to a certain filling level when the mixing container is filled with mix. The combination of internally hollow axle 5, its perforations 51 and the riser pipe 18 ensures pressure equalization by means of liquid exchange between the mixing container and the riser pipe during the rotating operation of the mixer and in particular during a simultaneous step of heating the mix during mixing. For this purpose, this embodiment also preferably has a heater (not shown in the figure). Also shown are two rollers 153, 154 running on the underside of the mixing container 2 for driving the cylindrical mixing container 2. In the preferred case, as noted for FIG. 2, the rollers 153, 154 would be combined into a single continuous roller running along the underside and along the entire length of the cylindrical mixing container.

FIG. 4 shows representations of a mixer according to the invention, namely as a sectional view (a), a perspective view (b) and a front view (c) with the end face of the mixer removed. The mixing container 2 is shown with two inlet openings 61 and one outlet opening 62. The mixing container 2 is rotatably mounted here on four rollers 153, 154, 155, 156. The sectional view (a) shows the rotatable mounting of the mixing container 2 by means of two rigid (descending hatched) axle sections 191,192, which protrude into two (increasingly hatched) bearings 81,82. An at least liquid-tight seal between rigid and rotating parts is achieved with seals 211,212. The mixing container 2 contains a rigid ultrasound source 35 in the form of a box profile or a square tube, which runs axially along approximately 90% of the length of the mixing container 2 and which is firmly connected to the two rigid axle sections 191, 192. This ultrasound source 35 has eight ultrasound generators inside (one is provided with reference number 23). The ultrasonic generators point their sound openings downwards and therefore have a sound direction that points outwards from the inside of the box profile or square tube. The box profile or square tube is sealed in an at least liquid-tight manner against the interior of the mixing container on its end faces by means of profile end plates 241,242 and by means of the axle sections 191, 192. The first axle section 191 proximal to the riser pipe 18 is hollow and has a perforation 51; it serves as a hollow axle 5 and, together with the riser pipe 18, ensures the pressure equalization described in the general section. The second axis section 192 proximal to the power connection 26 is designed as a rotary feedthrough for the electrical cables or lines 251,252. Firmly connected to the ultrasound source 35, and therefore also rigid, is an internal heater 11 in the form of a ceramic heating element, which has a graphite rod as an ohmic resistance on the inside. The power supply for the ultrasonic generators 23 is ensured by means of the cable or line 251 and the power supply for the internal heater 11 is ensured by means of the cable or line 252. The perspective view (b) shows the drive principle with the four rollers 153, 154, 155, 156. Of these, the roller 155 (see (a)) acts as a drive roller which transmits a torque to the outer surface 21 of the mixing container 2 by means of a motor with a gear 27 and thus sets it in rotation. The remaining rollers 153, 154, 156 run idle and support the mixing container 2 during its rotation. Shown again is the riser pipe 18, which ensures pressure equalization. Also shown is a control box 28 which contains the control and drive electrics necessary for controlling the ultrasound sources 23 and the motor/gear 27. The motor is typically a synchronous motor which allows a freely selectable speed of the mixing container 2 by means of a suitable number of poles and a suitable associated alternating voltage for each of the poles. In side view (c) the arrangement of the ultrasound source 35, the inner heater 11, the sieve 12 for separating part of the interior volume of the mixing container and four blades (one is provided with reference number 161) is illustrated. The removed end face would have the reference number 91. A closable opening 911 for emptying the mixing container is shown in dotted lines, which would also be present in the remote end face 91.

The mixer according to the invention is suitable for all processing methods in which a particulate solid as exemplified above is to be extracted with a liquid as exemplified above, the particulate solid being mixed thoroughly with the liquid. The mixer according to the invention provides by the combination of free-fall mixing and simultaneous sonication of the mixed material with ultrasound a much faster extraction of the particulate solid with the liquid. A preferred area of application for the mixer according to the invention is in beer brewing.

An extraction process according to the invention (in particular mashing) is analogous to a corresponding previously known process, but in which a mixer according to the invention is used as the extraction vessel (i.e. in particular as a mash tun). The process parameters of the process according to the invention can typically be identical to the corresponding previously known process, except that ultrasound is applied at the same time and the mixing container is rotated.

The extraction method according to the invention (in particular mashing) could also be analogous to any previously known corresponding extraction method, which only uses ultrasound but no rotation of the extraction vessel, but wherein at the same time the mixing container according to the invention which is used as an extraction container is also rotated. In such an extraction process according to the invention (in particular mashing), due to the synergy of sonication with ultrasound and rotation of the mixing container, a rotation of the mixing container could initially be freely selected, which is preferably in the range of 5-50 rpm, more preferably 10-30 rpm, and with this selected rotation of the mixing container:
a) with the ultrasound frequency and power remaining the same compared to the previously known corresponding previously known extraction process, the duration of the extraction process can be shortened to such an extent; and/or
b) with the ultrasound power and duration remaining the same compared to the corresponding previously known extraction process, the ultrasound frequency is reduced to such an extent; and/or
c) with the ultrasound frequency and duration remaining the same the power of the ultrasound is reduced to such an extent;
   that nevertheless the same extraction performance, or even a better extraction performance, out of the particulate solid (i.e. when mashing from the malt) is achieved. Preferably it is above alternative b); reducing the ultrasound frequency may mean a gentler extraction (avoidance of sonochemistry) and/or the use of simpler ultrasound sources and/or a longer service life of the mixer according to the invention. The comparison of the extraction performances could be over the extent and/or the speed of the extraction. In the case of a comparison between a previously known mashing with only ultrasound and mashing according to the invention with ultrasound and rotation of the mixing container, the comparison of the extraction performances would typically be via the determination of the Plato degrees. An “analog” method according to the invention is understood here as a method that, with regard to the essential process parameters, in particular the batch size (i.e. amount and type of particulate solid and liquid, i.e. during mashing, the amount and type of malt and amount and type of water) and the type of temperature program (i.e. the type and duration of the temperature intervals maintained during mashing) is the same as the corresponding previously known method that only uses ultrasound.

In all cases of the mashing process according to the invention, the usual removal of oxygen, as described in the introduction, can be omitted due to the interacting sonication with ultrasound and rotation of the mixing container.

In its most general form, without heating and without a grid built into the mixing container, it is particularly suitable for mashing in the decoction or infusion process. The mixer would typically take over the functions of the mash vat and the mash tun.

In its first preferred embodiment with heating but without the grid built into the mixing container, it is suitable for mashing using the kettle mashing process. The mixer would typically also take over the functions of the mash vat and the mash tun. Optionally, it could also be used for prior kilning.

In its second preferred embodiment with a grid built into the mixing container but without heating, it is suitable for the steps of mashing in the decoction or infusion process and lautering. The mixer would typically take over the functions of the mash vat, the mash tun and, under certain circumstances, the lauter vat. Due to the built-in sieve, the remaining malt can be washed with toppings and the toppings can be filtered off via the grid.

In its third, particularly preferred embodiment, with a grid and heating built into the mixing container, it is suitable for preliminary kilning, subsequent mashing using the kettle mashing process and subsequent lautering. The mixer would typically also take over the functions of the mash vat, the mash tun and, under certain circumstances, the lauter vat.

An exemplary brewing process using a mixer according to the above particularly preferred embodiment is described below, the mixer additionally comprising a pressure compensation or a level indicator with riser pipe (as explained in the general description and as shown in FIG. 3). The mixer also includes three vibrating plates arranged in the mixing container; the combination of vibrating plates arranged within the mixing container, their power supply and the transmission of the torque transmission required to rotate the mixing container is according to the first preferred embodiment of the general part of the description.

About 3000 kg of a standard barley malt that has been kilned and crushed to a suitable grain size and about 9000 liters of water are poured into the stationary mixing container via an opening pointing upwards, such as opening 61, and this opening is sealed with a closure 71, such as a screw cap, in a liquid-tight and/or gas-tight manner. All other openings that the mixing container 2 could have are already closed in liquid-tight and/or gas-tight manner with respective closures or wing valves.

The mixing container with the mixture of malt and water contained therein is rotated around the axis of rotation at approximately 5-15 rpm by means of the rollers 161, 162.

With the mixing container rotating, the mixture is mashed in at 40-45° C. and is heated, maintaining a protein rest at 50-55° C., a maltose rest at 63-65° C. and a saccharification rest at 73-74° C., up to a final temperature of 76-78° C., using an induction heater 11, which heats the metallic outer jacket of the mixing container 2. Compliance with the temperature gradients and the rests is monitored using the temperature sensors 161,162.

During the entire mashing the interior of the mixing container 2 is sonicated with ultrasound by means of the three vibrating plates 31, 32, 33 with a continuously adjustable power of approximately 10-50 W per ultrasound source, in particular per vibrating plate.

The entire mashing process takes about 2-8 hours depending on the filling. Due to the pressure equalization via the perforation(s) 51, the internally hollow axle 5 and the riser pipe 18, the excess pressure in the mixing container is never more than approximately 0.1 bar.

While the mixing container 2 is still hot, it is stopped so that the grid 12 present in the interior points downwards. The opening 62, which leads from the environment into the part 13 of the internal volume of the mixing container 2 separated by the grid 12, is opened, whereupon the mash is sieved through the grid and drained into a lauter vat via the opening 62. The volume compensation for the outflowing volume of mash can be done via the riser pipe 18, which now not only allows all of the liquid contained therein to flow back into the mixing container 2, but also allows ambient air to flow in. If desired, one of the other openings that leads into the non-separated part of the internal volume of the mixing container 2, such as the upward-pointing opening 61, is additionally opened in order to provide additional pressure equalization.

The opening 62 and any additional opening that provides additional pressure equalization are closed again with their associated closures.

The malt remaining in the mixing container is washed while again rotating the mixing container 2 and again under sonication with ultrasound with one or two after-pours, which are either heated beforehand or heated directly in the mixing container 2 itself by means of the heater 11, with the separation of the after-pours by means of filtration via the grid 12 being done as already described for the mash.

The filtered mash and the after-pours are mixed with hops in a separate wort kettle and boiled down to around 15° Plato.

The original wort obtained in this way is cooled, separated from the hop residues in a standard whirlpool and fermented with the addition of yeast.

The presence of the one or more ultrasonic sources also facilitates cleaning of the mixing container. For cleaning purposes, the remaining mix, in particular a portion of particulate solid remaining therefrom, is advantageously emptied over one of the openings in the mixing container (if the mixing container contains a grid, it would be an opening that opens into the rest of the interior volume of the mixing container). If the mixing container has a removable end face (see above), this end face can also be removed instead and the remaining portion of particulate solids can be emptied by tilting the mixing container. The mixing container is then filled with cleaning liquid, in particular pure water, and the opening is closed again or the front side. By rotating and applying ultrasound, efficient cleaning of the interior volume of the mixing container, in particular also of the holes of a perforated grid contained therein, is achieved.

### Example 1: Mashing Tests with a Mixer According to the Invention Using Ultrasound and/or Rotation of the Mixing Container

A mixer with a design according to FIG. 4 was used in all experiments, but it also had a small closable tap on the outer surface 22 of the mixing container 2, which was normally closed.

a) Mashing with Ultrasound and Rotation of the Mixing Container (According to the Invention)

9.2 kg of malt (mixture of 3.8 kg Pils and 5.4 kg light wheat) and 33 liters of normal city water (pH 6.5) were poured into the mixing container 2 via the openings 61 pointing upwards and these openings were sealed in a liquid-tight and gas-tight manner. No conventional degassing or exposure to an inert gas such as nitrogen or carbon dioxide was done. The mixing container 2 with the mixture of malt and water contained therein was rotated around the axis of rotation at 21 rpm by means of the rollers 161, 162. While the mixing container 2 was rotating, the mixture was first mashed in at 40-45° C., then mashed with maintaining a protein rest at 50-53° C. for 15 min, a maltose rest at 64° C. for 30 min, a saccharification rest at 73° C. for 20 min and a lauter rest at 76-77° C. for 10 min. These five temperature rests are indicated in FIG. 5 a) on the X-axis as the numbers 1, 2, 3, 4 and 5, respectively. During the entire mashing, the interior of the mixing container 2 was sonicated with ultrasound of 27 kHz and a total power of 400 watts using the ultrasound source 35 with the eight ultrasound generators 23 contained therein.

The wort was determined using standard procedures every 5 minutes on samples of the mix. For this purpose, to take a sample while the mixing container 2 was rotating and when the small tap was down, the tap was opened and a sample of the mix was drained into a cup and the tap was then closed again. On the Y-axis of FIG. 5 a), the measured increase in wort over the course of mashing is given in degrees Plato.

b) Mashing with Ultrasound and Rotation of the Mixing Container (According to the Invention)

The experiment according to a) above was repeated, except that the frequency of the ultrasound was 80 kHz. The five temperature rests complied are indicated again in FIG. 5 b) on the X-axis as the numbers 1, 2, 3, 4 and 5, respectively; on the Y-axis of FIG. 5 b) the measured increase in the wort during the course of mashing is given in degrees Plato.

c) Mashing without Ultrasound, but with Rotation of the Mixing Container (Comparative)

The experiment according to a) above was repeated, except that no ultrasound was applied. The five temperature rests are again on the X-axis in FIG. 5 c) as the numbers 1, 2, 3, 4 and 5, respectively; on the Y-axis of FIG. 5 c) the measured increase in the wort during the course of mashing is given in degrees Plato.

d) Mashing with Ultrasound, but without Rotation of the Mixing Container (Comparative)

The experiment according to above b) was repeated, except that no rotation of the mixing container was used. The five temperature rests are in FIG. 5 d) again on the X-axis as the numbers 1, 2, 3, 4 and 5, respectively; on the Y-axis of FIG. 5 d), the increase in wort measured during the course of mashing is given in degrees Plato.

Experiments a)-d) show that the combination of ultrasound and rotation of the mixing container has a synergistic effect in the increase in the degree of Plat as compared to the use of ultrasound alone or the use of rotation of the mixing container alone, especially at the beginning. In particular, the comparison between a) and d) shows that ultrasound at 27 kHz in combination with rotation of the mixing container at 21 rpm is more effective than ultrasound at 80 kHz without rotation of the mixing container.

1.-15. (canceled)

16. A mixer comprising:
a mixing container with an interior volume, an inner surface, and an outer surface, and which is capable of rotating about an axis of rotation, the mixer comprising:
at least one ultrasound source which is capable of sonicating at least part of the interior volume with ultrasound, the at least one ultrasound source defined by at least one vibrating plate arranged in the interior volume of the mixing container, or at least one box profile or square tube including one or more ultrasound sources in an interior thereof;
wherein the mixing container is configured to receive application of torque transmitted directly onto the outer surface of the mixing container and to rotate in response to receiving said torque by means of a rigid axle that is freely rotatable relative to the mixing container and that runs along the axis of rotation, the mixing container comprising two bearings that permit free rotation of the mixing container relative to the rigid axle, the rigid axle defined by either a single axle that runs through an entire length of the mixing container or two axle sections that run along the axis of rotation of the mixing container but not along its entire length, wherein the two axle sections each protrude into one of the two bearings of the mixing container.

17. The mixer according to claim 16, further comprising one or more liquid and/or gas-tight sealable openings for receiving a mix to be mixed in the mixing container and/or for removing mix from the mixing container.

18. The mixer according to claim 16, wherein the axis of rotation is horizontal or deviates from horizontal by not more than 20°.

19. The mixer according to claim 16, wherein the mixing container is rotationally symmetrical about an axis of symmetry.

20. The mixer according to claim 19, wherein the mixing container further comprises a cylindrical lateral surface and two end faces, and wherein one or more of:
a) the axis of symmetry coincides with the axis of rotation; or
b) the axis of symmetry is inclined relative to the axis of rotation; or
c) the axis of symmetry runs parallel to the axis of rotation but is offset relative to the axis of rotation.

21. The mixer according to claim 20, wherein at least one of the two end faces is removable from the mixing container.

22. The mixer according to claim 16, further comprising an external or internal heater or cooler for heating or cooling the mixing container.

23. The mixer according to claim 16, further comprising a grid in the internal volume of the mixing container that separates a part of the internal volume of the mixing container adjacent to the inner surface of the mixing container from a remainder of the internal volume of the mixing container, and wherein the mixing container has at least two liquid-tight sealable openings, of which at least a first opening opens into the remainder of the internal volume and is configured to receive into the remainder of the interior volume a mix to be mixed and/or is capable of removing mix from the remainder of the interior volume, and at least one second opening opens into the separated part of the interior volume and is configured to remove liquid from the separated part of the interior volume.

24. The mixer according to claim 23, wherein the grid is a perforated grid having holes with a hole diameter in the range of 0.1 to 1.3 mm.

25. The mixer according to claim 16, wherein:
i) the single axle is hollow, has one or more perforations that establish a liquid-conducting connection between the interior volume of the mixing container and an internal cavity of the hollow axle, and the hollow axle is connected in a liquid-conducting manner to an upwardly open riser pipe; or
ii) of the two axle sections, a first axle section is hollow and has one or more perforations that establish a liquid-conducting connection between the interior volume of the mixing container and an internal cavity of the hollow first axle section, and the hollow first axle section is connected in a liquid-conducting manner with a riser pipe which is open at the top; in such a way that, when the mixing container is filled with a mix comprising a liquid, the liquid fills the internal cavity of the internally hollow axle or the internal cavity of the internally hollow first axle section, respectively, and the riser pipe up to a height that creates a hydrostatic pressure equal to an internal pressure in the mixing container, wherein an increase in the internal pressure in the mixing container is compensable by displacing further liquid from the mixing container via the one or more perforations into the internally hollow single axle or into the internally hollow first axle section, respectively, and into the riser pipe, and a decrease in the internal pressure in the mixing container is compensable by backflow of liquid from the riser pipe via the internally hollow single axle or via the internally hollow first axle section, respectively, through one or plurality of perforations into the mixing container.

26. The mixer according to claim 16, wherein the mixing container is filled with a mix comprising barley malt and water.

27. The mixer according to claim 16, wherein the mixer is configured for beer brewing or for extraction of plants or plant parts.

28. The mixer according to claim 27, wherein the mixer lacks a heater and a grid inserted into the mixing container, and the mixer is configured for mashing in a decoction or infusion process.

29. The mixer according to claim 27, wherein the mixer lacks a grid inserted into the mixing container and the mixer is configured for mashing in a kettle mashing process.

30. The mixer according to claim 27, wherein the mixer comprises an external or internal heater or cooler for heating or cooling the mixing container.

31. The mixer according to claim 27, further comprising a first grid in the internal volume of the mixing container, which first grid separates a part of the internal volume of the mixing container adjacent to the inner surface of the mixing container from a remainder of the internal volume of the mixing container.

32. The mixer of claim 31, further comprising a second grid inserted in the mixing container or a heater, wherein the mixer is configured for mashing in a kettle mashing process and for lautering.

33. The mixer according to claim 23, wherein the hole diameter is selected from the group consisting of: about 1.25 mm, about 1 mm, about 0.5 mm and about 0.25 mm.

34. The mixer according to claim 18, wherein the axis of rotation deviates from horizontal by not more than 10°.

35. The mixer according to claim 34, wherein the axis of rotation deviates from horizontal by not more than 5°.
